(19) United States
(12) Patent Application Publication
(10) Pub. No.: US 2008/0162247 A1
(43) Pub. Date: Jul. 3, 2008

(54) Apparatus, method and computer program product providing calendar application including modular time units, invitee monitoring and man-time unit scheduling capability

(75) Inventors: Jussi Hurmola, Tampere (FI); Sampo J. Savolainen, Espoo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/646,895

(22) Filed: Dec. 28, 2006

(51) Int. Cl. G06F 9/46

(52) U.S. Cl. 705/9

(57) ABSTRACT

A method includes receiving a scheduling event at a calendar application from a user, where the scheduling event includes at least an identification of a task and an amount of time needed to complete the task; monitoring a calendar of the user with the calendar application to identify an unscheduled period of time having a duration at least equal to the time needed to complete the task; and notifying the user of an identified unscheduled period of time having the duration at least equal to the time allocated to complete the task. In the method the scheduling event may further comprise an identification of a period of time in which to complete the task. The scheduling request may include at least a time and a list of proposed participants for a proposed event, and in this case the method includes sending invitations to the proposed event from the calendar application, via at least one interface, to the proposed participants; and the calendar application monitoring received invitation responses for fulfillment of at least one criterion for determining if the proposed event is to be a scheduled event. The scheduling request may also include at least a list of proposed participants for a proposed event and a duration of the event expressed in a man-[time unit] format that is converted to calendar time based on the list of proposed participants. Also disclosed is a master calendar event that is comprised of links to a plurality of calendar events.

### TECHNICAL FIELD

The exemplary embodiments of this invention relate generally to user interfaces for devices and methods pertaining to same and, more specifically, relate to calendar-type and similar scheduling-capable and time management applications.

### BACKGROUND

An automated calendar application is typically used in a manner similar to that of a traditional list of reminders written into a book or other paper medium. Decision making and simple tasks are all manually determined and added to the calendar. The calendar is based on singleton events which are communicated through some invitation-type of explanation of an event content and time of occurrence.

Time is a resource that everyone understands and has access to. In the modern information community the amount of data can easily swamp an individual, hindering the individual's work performance and enjoyment of personal life. Information arranging systems have traditionally concerned mostly the information external to the person. However, in the information era one's personal information, and the management of that personal information, becomes an important factor in a person's effectiveness and independence. A personal resource that is often underrated or totally overlooked is Time.

As is noted by A. Niemi (Nokia Research Center) in Internet-Draft: Session Initiation Protocol Event Packages for Calendering, draft-niemi-sipping-cal-events-01, expired Sep. 7, 2006, calendar sharing enables a user to subscribe to receiving information of a specific remote calendar. This calendar can represent the calendar entries of a particular user's daily schedule, or any other type of calendar information such as the release schedule of an open source software project.

Niemi discusses several preexisting standards, and works in progress, in the area of calendaring. Most notably, the Internet Scheduling Core Object Specification (iCalendar), (see Dawson, F. and Stenerson, D., “Internet Calendaring and Scheduling Core Object Specification (iCalendar)”, RFC 2445, Nov. 1998), the iCalendar Transport-Independent Interoperability Protocol (iTIP), (see Silverberg, S., Mansour, S., Dawson, F., and R. Hopson, “iCalendar Transport-Independent Interoperability Protocol (iTIP) Scheduling Events, BusyTime, To-dos and Journal Entries”, RFC 2446, November 1998), define the data format, and its binding to Internet email (see Dawson, F., Mansour, S., and S. Silverberg, “iCalendar Message-Based Interoperability Protocol (iMIP)”, RFC 2447, November 1998).

RFC 3265 (Roach, A., “Session Initiation Protocol (SIP)-Specific Event Notification”, June 2002) defines an event subscription and notification framework that can be used to subscribe to different types of events related to SIP systems. A publication counterpart, defined in RFC 3903 (Niemi, A., “Session Initiation Protocol (SIP) Extension for Event State Publication”, RFC 3903, October 2004), allows for a SIP user agent to publish event state into a central compositor that then distributes this information to the subscribers of that event package.

The Niemi Internet draft (draft-niemi-sipping-cal-events-01) defines two new event packages for calendaring events; the first allows sharing of calendar events and the second enables scheduling events related to calendaring. Using these two event packages there is defined, in effect, an iTIP mapping to SIP.

Niemi defines several related concepts as follows: Calendar User Agent: a SIP user agent that acts on the behalf of the calendar user, Calendar Server: a SIP user agent responsible for accepting subscriptions and sending out notifications containing calendar data, Calendar Watcher: a SIP user agent responsible for issuing subscriptions and processing notifications of calendar events.

The background of calendar sharing and scheduling applications as summarized by Niemi as dating back several years. Especially in the enterprise domain, these applications have been commonplace for nearly a decade. Many enterprise collaboration tools have provided enterprise users with tools that enable calendar access, as well as the ability to schedule meetings and other calendar entries among the users.

Tools based on proprietary protocols have provided very little interoperability, and generally have not allowed inter-organizational calendar access. Being able to schedule meetings across organizations necessitates the availability of: interoperable data formats, interoperable sharing and scheduling protocols and reasonable means of access control and channel security.

The availability of the first is all but guaranteed at present. The iCalendar format and its predecessor, the vCalendar format (see Internet Mail Consortium, “vCalendar—The Electronic Calendaring and Scheduling Exchange Format”, http://www.imc.org/pdi/vcal-10.txt, September 1996) are nearly ubiquitous and supported currently by a majority of Personal Information Management (PIM) applications.

Some solutions for calendar sharing and scheduling have been available based on standard components, such as by being based on HTTP (see Fielding, R., Gettys, J., Mogul, J., Frystyk, H., Masinter, L., Leach, P., and T. Berners-Lee, “Hypertext Transfer Protocol—HTTP/1.1”, RFC 2616, June 1999) and WebDAV (see Goland, Y., Whitehead, E., Faizi, A., Carter, S., and D. Jensen, “HTTP Extensions for Distributed Authoring—WEBDAV”, RFC 2518, February 1999) extensions. Recent efforts have proposed CalDAV as a standard calendar access protocol based on WebDAV. Extending calendaring applications beyond a single administrative domain requires that the protocols allow reasonable means for user identification, authentication and access control.

However, there are deficiencies in the various currently available calendar-related and scheduling-related applications. For example, assume that a person wants to propose a training schedule, or a travel agency wants to display a package holiday. Currently there is no way for the proposing party to synchronize an event or a series of events to a user's calendar for review and/or modification by the user.

The above-reference Niemi approach may suggest that there be more that one calendar per user, which may be problematic from a time management standpoint.

Further, in conventional calendar applications there is no facility to send a modular meeting request which distributes a single event to a plurality sub-events and that maintains the inseparability of the sub-events.

Further, in conventional calendar applications there is no facility to create a calendar event which inseparably maintains sub-events in different calendars of different users, and that and modifies automatically the man-months (or some similar participant dependent count) to calendar time upon sending invitations.

Further, in conventional calendar applications there is no facility to specify a time frame inside which a task should be accomplished, and during the time frame automatically reminds a user at suitable times of the task.

It is known that at least one application program (MS Outlook™) enables specifying a task with a deadline warning. However, the deadline warning is initiated by the approaching deadline, and not the suitability of the time according to the users calendar.

Further, at least some conventional calendars specify a recurring or single appointment, but do not provide modular, or distributed and automatically converted events (e.g., man-months to calendar months).

In addition, it is currently not possible to create a calendar event that concerns some arbitrary number of people for fulfilling a certain criteria of an event, such as an organization meeting that requires the attendance of some certain number of members in order to vote on a particular item of interest.

Further, and while work-related tasks can be typically defined in man-months or man-days, at present there is no facility to create and distribute a calendar event which will only be scheduled if certain relationships and criteria is fulfilled.

A manual approach to this problem would involve manually creating a list of participants, then contacting the participants via email or phone, and then constantly monitoring the event to determine whether some predetermined number of the participants have accepted and, if not, manually canceling the event. But it will be a mess when the user needs a specific calendar to divide between requests.

The above-reference Niemi approach may suggest that there be more that one calendar per user, which may be problematic from a time management standpoint, and furthermore instead of defining the parameters in events, these would be divided between the plural user calendars. This approach would be also be problematic when the user desires a specific calendar to divide between requests.

Further, currently it is not possible to create a calendar entry (a master entry) that includes other calendar entries which can be modified while linked to the master entry. Instead, the user is presented with a collection of singular entries which are linked to each other only through knowledge of the user or possibly in some other tool. Each of these singular entries thus requires separate attention and management.

More specifically, calendars currently have tasks, events and appointments, but these cannot be linked together as some master event to be sent as a single invitation or otherwise linked together. Instead the single occurrences need to be separately maintained and managed.

The above-mentioned Niemi approach suggests more that one calendar for a single user and, instead of defining the parameters in the events, these would be divided between the plurality of calendars. This calendar cannot conceptually send an invitation of linked events since the events may point to different calendars at the receiving user's side, thereby significantly complicating the management task of the receiving user.

### SUMMARY OF THE EXEMPLARY EMBODIMENTS

The foregoing and other problems are overcome, and other advantages are realized, in accordance with the non-limiting and exemplary embodiments of this invention.

In accordance with the exemplary embodiments of this invention there is provided a method that includes receiving a scheduling event at a calendar application from a user, the scheduling event comprising at least an identification of a task and an amount of time needed to complete the task; monitoring a calendar of the user with the calendar application to identify an unscheduled period of time having a duration at least equal to the time needed to complete the task; and notifying the user of an identified unscheduled period of time having the duration at least equal to the time allocated to complete the task. In the method the scheduling event may further comprise an identification of a period of time in which to complete the task, and where monitoring may comprise monitoring the calendar within the period of time.

Further in accordance with the exemplary embodiments of this invention there is provided a method that includes receiving from a user a scheduling request at a calendar application, the scheduling request comprising at least a time and a list of proposed participants for a proposed event; sending invitations to the proposed event from the calendar application, via at least one interface, to the proposed participants; and the calendar application monitoring received invitation responses for fulfillment of at least one criterion for determining if the proposed event is to be a scheduled event.

Further in accordance with the exemplary embodiments of this invention there is provided a method that includes receiving from a user a scheduling request at a calendar application, the scheduling request comprising at least a list of proposed participants for a proposed event and a duration of the event expressed in a man-[time unit] format; converting the man-[time unit] to calendar time based on the list of proposed participants; sending invitations to the proposed event from the calendar application, via at least one interface, to the proposed participants, the invitations including the calendar time; and the calendar application monitoring received invitation responses and modifying the calendar time as needed.

Further in accordance with the exemplary embodiments of this invention there is provided a method that includes receiving from a user a scheduling request at a calendar application, the scheduling request comprising a set of modular units; sending an invitation to at least one invitee; and receiving a response to the invitation, the response comprising an approval or a rejection of the set of modular units.

Further in accordance with the exemplary embodiments of this invention there is provided a device that includes a calendar application unit and a user interface adapted to receive a scheduling event from a user and having an output coupled to the calendar application unit. The scheduling event includes at least an identification of a task and an amount of time needed to complete the task. The calendar application unit is configured to monitor a calendar of the user to identify an unscheduled period of time having a duration at least equal to the time needed to complete the task, and to notify the user via the user interface of an identified unscheduled period of time having the duration at least equal to the time allocated to complete the task.

Further in accordance with the exemplary embodiments of this invention there is provided a device that includes a calendar application unit and a user interface adapted to receive a scheduling request from a user. The user interface has an output coupled to the calendar application unit. The scheduling request comprises at least a time and a list of proposed participants for a proposed event. The calendar application unit is adapted to send invitations to the proposed event, via at least one interface, to the proposed participants and is further configured to monitor received invitation responses for fulfillment of at least one criterion for determining if the proposed event is to be a scheduled event.

Further in accordance with the exemplary embodiments of this invention there is provided a device that includes a calendar application unit and a user interface adapted to receive a scheduling request from a user. The user interface has an output coupled to the calendar application unit. The scheduling request includes at least a list of proposed participants for a proposed event and a duration of the event expressed in a man-[time unit] format. The calendar application unit is configured to convert the man-[time unit] to calendar time based on the list of proposed participants and to send invitations to the proposed event, via at least one interface, to the proposed participants. The invitations include the calendar time. The calendar application unit is further configured to monitor received invitation responses and to modify the calendar time in accordance with received invitation response, as needed.

Further in accordance with the exemplary embodiments of this invention there is provided a device that includes a calendar application unit and a user interface adapted to receive a scheduling request from a user. The user interface has an output coupled to the calendar application unit. The scheduling request comprises a set of modular units, and the calendar application unit is configured to send an invitation to at least one invitee, via an interface, and to receive a response to the invitation via the interface, where the response comprises an approval or a rejection of the set of modular units.

Further in accordance with the exemplary embodiments of this invention there is provided a method that includes receiving user input at a calendar application to create a master calendar event comprising links to a plurality of calendar entries; storing data expressive of the master event; and sending the master event to at least one recipient, where sending comprises sending all of the linked calendar entries.

Further in accordance with the exemplary embodiments of this invention there is provided a device that includes a calendar application unit and a user interface to apply user input to the calendar application unit, the calendar application unit is configured to create a master calendar event comprising links to a plurality of calendar entries, to store data expressive of the master event, and is further configured to send the master event to at least one recipient, where sending the master event comprises sending all of the linked calendar entries.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a simplified block diagram an embodiment of a wireless communications device suitable for practicing the exemplary embodiments of this invention;

FIG. 2 is a block diagram showing a calendar application coupled to a user interface and to a calendar that is suitable for use in implementing certain exemplary embodiments of this invention;

FIG. 3 is a block diagram showing the calendar application coupled to the user interface and to an address book that is suitable for use in implementing certain exemplary embodiments of this invention;

FIGS. 4-7 are each a logic flow diagram that is illustrative of various methods, and computer program products, for practicing the exemplary embodiments of this invention;

FIG. 8 is a block diagram showing the calendar application coupled to the user interface and to a calendar wherein a plurality of entries (events) are linked to a master entry (event) in accordance with a further exemplary embodiment of this invention; and

FIG. 9 is a logic flow diagram that is illustrative of a method and computer program product for practicing the exemplary embodiment shown in FIG. 8.

### DETAILED DESCRIPTION

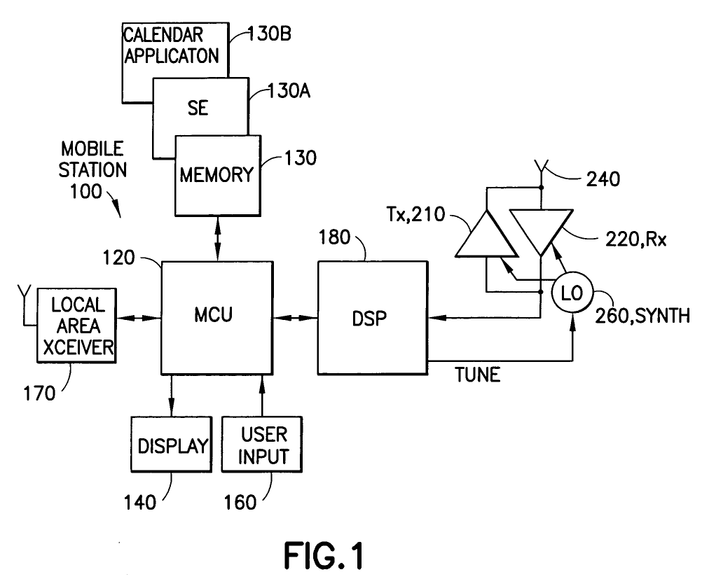

Referring to FIG. 1 there is shown as a simplified block diagram an embodiment of a device, such as a wireless communications device or mobile station 100, that is suitable for practicing the exemplary embodiments of this invention.

It should first be noted that while the exemplary embodiments of the invention will be shown and described as being practiced in a device such as wireless communications terminal, in general the teachings of this invention apply to any type of electronic device that is capable of hosting a calendar/scheduling application software. Thus, the exemplary embodiments of this invention may be used in desktop computers and workstations, laptop computers, notebook computers and personal digital assistants (PDAs), to name just a few of the many possible devices that can benefit from the use of the exemplary embodiments of this invention. As such, it should be appreciated that the description of the mobile station (MS) 100 in FIG. 1 is not intended to be read in any way as a limitation upon the use and possible implementations of the exemplary embodiments of this invention.

Still referring to FIG. 1, the mobile station 100 typically includes a control unit or control logic, such as a microcontrol unit (MCU) 120, having an output coupled to an input of a display 140 and an input coupled to an output of a user input 160, such as a real or virtual keyboard or keypad and that may include some type of pointing device such as, but not limited to, a stylus, a mouse or a touch-sensitive display screen. The mobile station 100 may be a handheld radiotelephone, such as a cellular telephone or a personal communicator. The mobile station 100 could also be contained within a card or module that is connected during use to another device. For example, the mobile station 100 could be contained within a PCMCIA or similar type of card or module that is installed during use within a portable data processor, such as a laptop or notebook computer.

In general, the various embodiments of the MS 100 can include, but are not limited to, cellular phones, personal digital assistants (PDAs) and portable computers, and may include or incorporate, as non-limiting examples, image capture devices such as digital cameras, gaming devices, music storage and playback appliances, Internet appliances permitting Internet access and browsing, as well as units or terminals that incorporate combinations of such functions.

The MCU 120 is assumed to include or be coupled to some type of a memory 130, typically including a non-volatile memory for storing an operating program and other information, as well as a volatile memory for temporarily storing required data, scratchpad memory, received data, data to be transmitted, and the like. The operating program is assumed, for the purposes of this invention, to enable the MCU 120 to execute the software routines, layers and protocols required to implement the methods in accordance with the exemplary embodiments of this invention, as well as to provide a suitable user interface (UI), via display 140 and user input 160, with a user. Although not shown, a microphone and speaker may be provided for enabling the user to conduct voice calls in a conventional manner.

Stored in the memory 130 is assumed to be a data structure that is descriptive of at least one scheduled event (SE) 130A, such as meetings, and may be embodied as a calendar of the user. The SE data structure 130A is established, managed and used in accordance with the exemplary embodiments of this invention. Associated with the SE 130A is a scheduled event application, which may be referred to for convenience as a calendar application 130B or as a calendar application unit 130B. The calendar application 130B may comprise computer executable program code that interacts with the data structure that is descriptive of the SE 130A, and is suitable for use in implementing the exemplary embodiments of this invention, as described more fully below.

The mobile station 100 also typically contains a wireless section that includes a digital signal processor (DSP) 180, or equivalent high speed processor or logic, as well as a wireless transceiver that includes a transmitter 200 and a receiver 220, both of which are coupled to at least one antenna 240 for communication with a network operator. At least one local oscillator, such as a frequency synthesizer (SYNTH) 260, is provided for tuning the transceiver. Data, such as digitized voice and packet data, is transmitted and received through the antenna 240. The wireless section may be considered to function as a long range interface (e.g., hundreds or thousands of meters) to a base station coupled to a communications network, such as a cellular operator network and/or the Internet. Note that the MS may also include a local area wireless transceiver (Xceiver) 170, such as one based on Bluetooth™ low power RF or infrared (IR) technology. The local area transceiver 170 may be considered as a short range interface (e.g., meters or tens of meters) for coupling to a wireless local area network (WLAN) via a suitable access point.

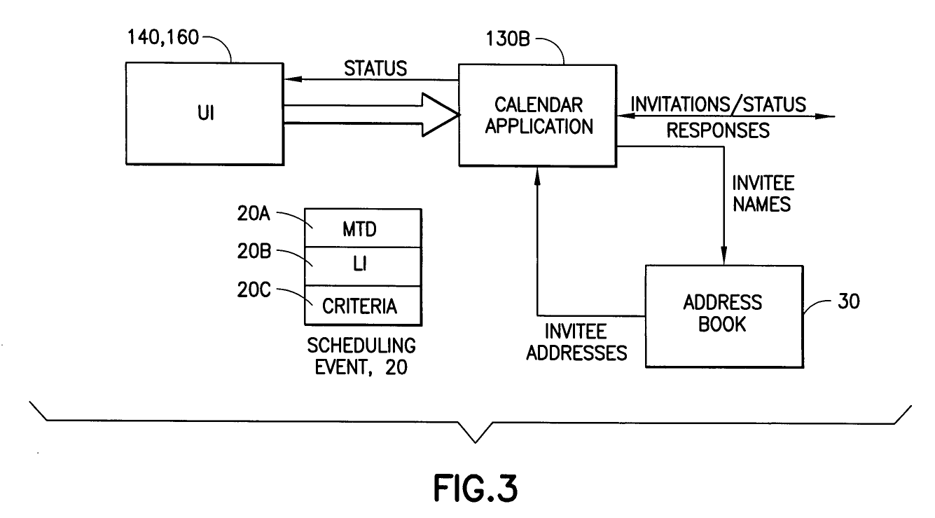

The exemplary embodiments of this invention may be implemented by computer software (e.g., the calendar application 130B) executable by a data processor of the mobile station 100, such as the processor 120, or by hardware, or by a combination of software and hardware. Further in this regard it should be noted that the various blocks of the logic flow diagram of FIG. 3 (described below) may represent program steps, or interconnected logic circuits, blocks and functions, or a combination of program steps and logic circuits, blocks and functions.

The memory 130 may be of any type suitable to the local technical environment and may be implemented using any suitable data storage technology, such as semiconductor-based memory devices, magnetic memory devices and systems, optical memory devices and systems, fixed memory and removable memory. The data processor(s) 120, 180 may be of any type suitable to the local technical environment, and may include one or more of general purpose computers, special purpose computers, microprocessors, digital signal processors (DSPs) and processors based on a multi-core processor architecture, as non-limiting examples.

In general, the various exemplary embodiments may be implemented in hardware or special purpose circuits, software, logic or any combination thereof. For example, some aspects of the exemplary embodiments of this invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

In accordance with exemplary embodiments of this invention there is provided with a calendar application 130B that is modular, that can provide a quota amongst more than one participant, and that furthermore may provide an ability to have a conditional short task (a sub-task) within a longer time period calendar entry.

In a first non-limiting example of the use of the improved calendar application 130B there is provided an ability for a user to send an invitation for a training session having a plurality of modular units, and the receiver (the invitee) may approve or reject the entire set of modular units.

In a second non-limiting example of the use of the calendar application 130B there is provided an ability for a project manager to send a two man-month invitation to a consultant team consisting of eight consultants. The calendar application 130B first sets the duration of the task to one week. Assuming that only four of the eight consultants accept the invitation, the calendar application 130B automatically resets the duration to two weeks (as fewer consultants have accepted, the task will take proportionally longer to accomplish) and re-sends the revised invitation to the four consultants that previously accepted. These four consultants then have the opportunity to accept the longer time commitment or to reject it.

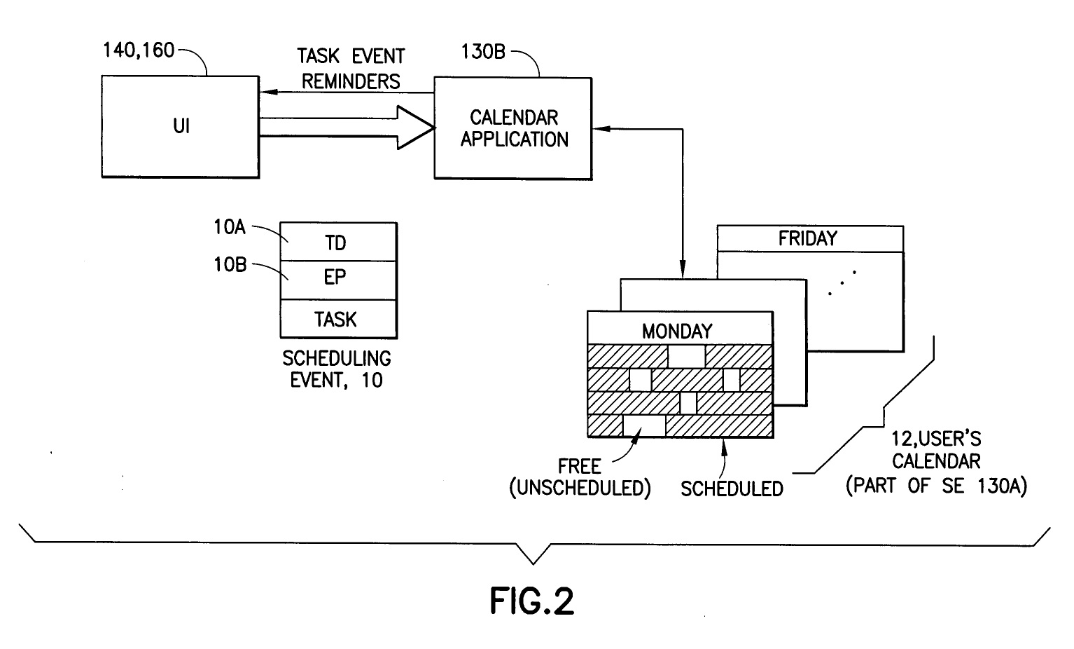

To illustrate a third non-limiting example of the use of the calendar application 130B, assume a case where a user is expected to perform sometime during a single week one 30 minute task (e.g., filling out an application). Referring to FIG. 2, the user interacts with the calendar application 130B via the user interface (140, 160) to set a calendar scheduling (task) event 10 with a task duration (TD) 10A of 30 min and an execution period (EP) 10B of within one week, with start and end dates and times specified (e.g., Monday at 8:00 AM and Friday at 5:00 PM). The calendar application 130B automatically monitors the task event 10, and the user's calendar 12 for the specified week, and reminds the user of the task event 10 for each 30 minute, or longer, free slot in the user's calendar 12. The calendar application 130B may, for example, inform the user at the start of each day of any at least 30 minute long unscheduled blocks of time in the user's calendar for that day, thereby giving the user the ability to schedule the 30 minute task event 10 for completion at some available time during that day. The user informs the calendar application 130B of the completion of the task so that the calendar application 130B can terminate the reminders.

The calendar application 130B may thus provide an event type with multiple start and end times to create a modular and inseparable entry. The calendar application 130B further has the functionality to specify the duration of an event as some type of Man-[time unit] (e.g., Man-month(s), Man-week(s)) and to calculate the calendar-time duration based on man-[time unit] and the number of persons associated with the calendar entry. The calendar application 130B further has an event type 10 for which the user can specify start and end times during which an event or task of user specified duration is to be performed (e.g., specify a task of 30 minute duration to be accomplished sometime during a specified five day interval, as in the example provided above). In this case the task duration should not exceed the surrounding event-time frame duration, and the start and end points should not be specified to be outside of the duration of the event-time frame. During the event time frame the calendar application 130B informs the user whenever there is a suitable timeslot available for the task event 10 contained by the time frame calendar entry.

As should be appreciated, at least one advantage of the use of the exemplary embodiments of this invention is that the user is not required to manually maintain a task log and to browse the task log to see whether there is a task that can be accomplished. Instead, the calendar application 130B notifies the user of uncompleted tasks by comparing task durations to calendar entries and free slots. At least one additional advantage of the use of the exemplary embodiments of this invention is that the user is enabled to send a modular task to invitees to specify all occurrences of the calendar entry and to ensure that when an invitee accepts an entry that the invitee accepts all of the modules. The calendar application 130B is enabled to automatically convert a man-[time unit] to calendar time based on an invitation list of an associated calendar event.

Discussing now further embodiments of the invention, and referring to FIG. 3, the calendar application 130B provides an n-to-n relationship of persons and calendar events. For example, assume that a user schedules a meeting (a proposed event) for an organization. A scheduling event 20 input to the calendar application 130B includes the meeting time and date(s) (MTD) 20A, as well as a list of invitees (LI) 20B. In response, and if not explicitly provided in the scheduling event 20, the calendar application 130B fetches the addresses (e.g., email addresses) of the individual group participants from a database, such as a contacts database (e.g., an address book 30), and sends the invitations via one or more appropriate interfaces (such as the long range transceiver 210,220, or the local area transceiver 170, or by some suitable wired network connection). The calendar application 130A then monitors some criterion or criteria 20C, such as the user providing an indication of some minimum number of attendees for the meeting to take place, and/or out of a total of n invitees at least the key person invitees Smith, Jones and Brown must accept.

If the criteria 20C are not fulfilled the calendar application 130B can re-send the invitation to those parties who rejected the invitation (or did not respond at all), and may attach text, such as a note stating, for example, that their rejection will result in the entire event being cancelled. If the criteria are still not met by some predetermined time prior to the scheduled meeting (e.g., 3 days, one week, as, possibly defined by the user), the calendar application 130B automatically provides the event status to the user and all those invited parties who had accepted the event invitation. In this case the event status notification can be that the meeting was cancelled (not scheduled) due to insufficient response, such as because an insufficient number of people would attend the meeting to form a quorum in the event a vote needed to be taken. Alternatively, if the criteria 20C are met the calendar application 130B may send as the status an event confirmation (the event has been scheduled) to the user and invitees who have accepted the invitation.

As a further example, assume that a user has a consultation task abroad for two man-months, and the calendar application 130B sends an invitation to the consultant member group. The calendar application 130B fetches the addresses of the group members from the contacts (address book 30). The calendar application 130B automatically calculates the calendar time needed for a two man-month task for the number of persons in the consultant member group based on availability information from the calendars of the responding group members. If one or more invitees reject the invitation to participate in the task, the calendar application 130B re-sends the invitation with the new (revised) time required to accomplish the task (e.g., now possibly three man-months).

As a further example, the user sends an invitation for an organization meeting. In this case the calendar application 130B checks that mandatory number of participants accept (e.g., 10) and that a sufficient number of optional participants accept (e.g., 5). In this case the meeting can be automatically cancelled if one or more of the mandatory participants rejects the invitation, and the calendar application 130B re-sends the invitation if a sufficient number of optional attendees do not accept. This can include changing the status of at least some of the optional participants to be mandatory, and adding a textual explanation to the invitation.

In these various embodiments the calendar application 130B partitions time amongst contacts group members, and furthermore links participants to a calendar event with acceptance importance and some overall acceptance parameter. The calendar application 130B monitors the replies from the invited parties and acts based on this information. If certain criteria cannot be fulfilled, the calendar application 130B notifies the user and may cancel the event (or simply not schedule the event). The calendar application 130B may also modify one or more of the participant list, certain participant parameters (e.g., mandatory, optional) and the duration of the event and may re-send the modified invitation.

By the use of these exemplary embodiments of the invention the user need not directly monitor the replies of members of an invited group, as the calendar application 130B is enabled to perform this task with little or no user involvement.

In all of these various embodiments the number of invitees may be one or more.

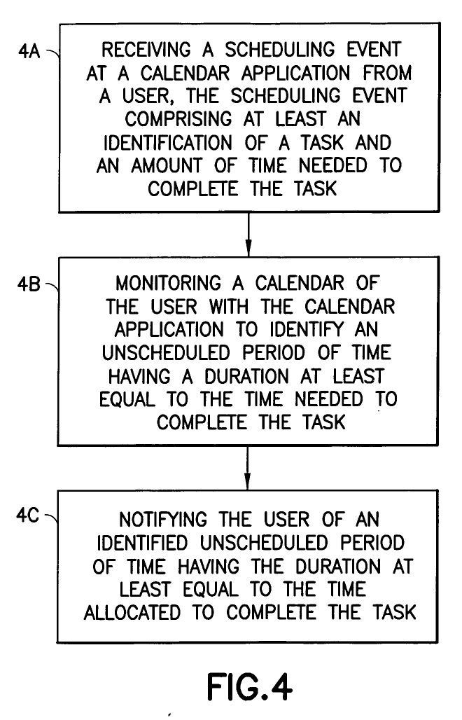

Based on the foregoing description, and referring to FIG. 4, it can be appreciated that in accordance with an exemplary embodiment of this invention a method includes: (Block 4A) receiving a scheduling event at a calendar application from a user, the scheduling event comprising at least an identification of a task and an amount of time needed to complete the task; (Block 4B) monitoring a calendar of the user with the calendar application to identify an unscheduled period of time having a duration at least equal to the time needed to complete the task; and (Block 4C) notifying the user of an identified unscheduled period of time having the duration at least equal to the time allocated to complete the task. In the method the scheduling event may further comprise an identification of a period of time in which to complete the task, and where monitoring in Block 4B may comprise monitoring the calendar within the period of time.

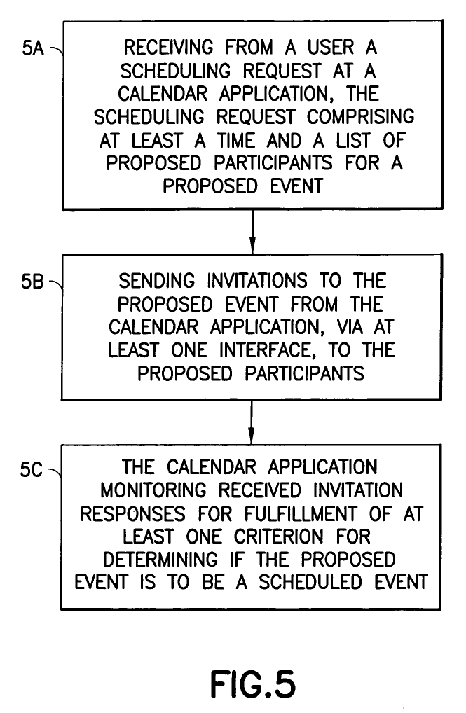

Based on the foregoing description, and referring to FIG. 5, it can be appreciated that in accordance with an exemplary embodiment of this invention a further method includes: (Block 5A) receiving from a user a scheduling request at a calendar application, the scheduling request comprising at least a time and a list of proposed participants for a proposed event; (Block 5B) sending invitations to the proposed event from the calendar application, via at least one interface, to the proposed participants; and (Block 5C) the calendar application monitoring received invitation responses for fulfillment of at least one criterion for determining if the proposed event is to be a scheduled event.

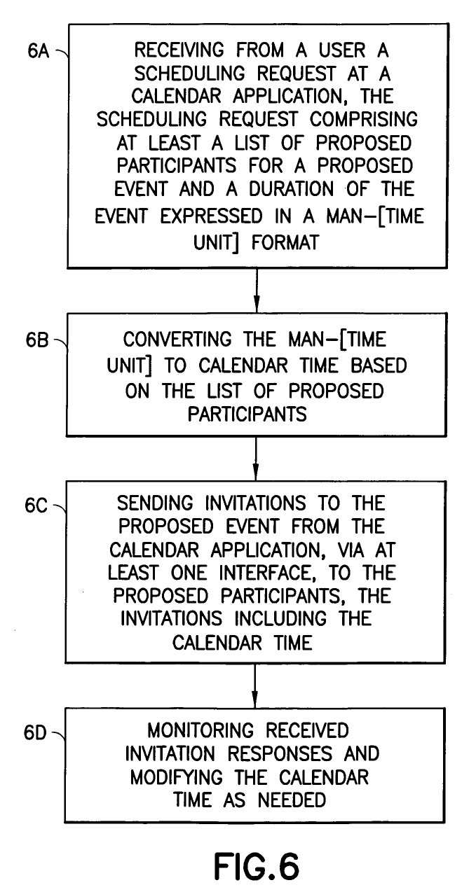

Based on the foregoing description; and referring to FIG. 6, it can be appreciated that in accordance with an exemplary embodiment of this invention a further method includes: (Block 6A) receiving from a user a scheduling request at a calendar application, the scheduling request comprising at least a list of proposed participants for a proposed event and a duration of the event expressed in a man-[time unit] format; (Block 6B) converting the man-[time unit] to calendar time based on the list of proposed participants; (Block 6C) sending invitations to the proposed event from the calendar application, via at least one interface, to the proposed participants, the invitations including the calendar time; and (Block 6D) the calendar application monitoring received invitation responses and modifying the calendar time as needed.

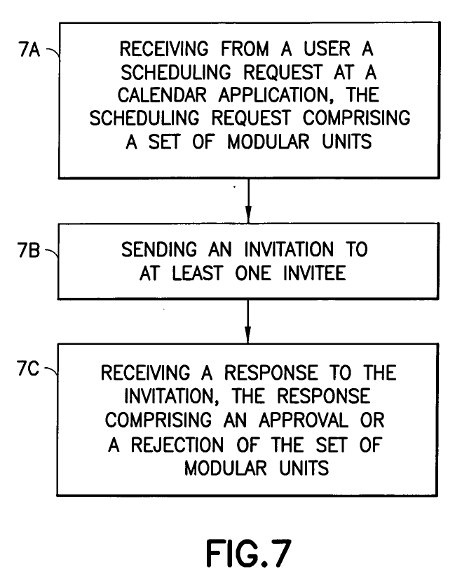

Based on the foregoing description, and referring to FIG. 7, it can be appreciated that in accordance with an exemplary embodiment of this invention a further method includes: (Block 7A) receiving from a user a scheduling request at a calendar application, the scheduling request comprising a set of modular units; (Block 7B) sending an invitation to at least one invitee; and (Block 7C) receiving a response to the invitation, the response comprising an approval or a rejection of the set of modular units.

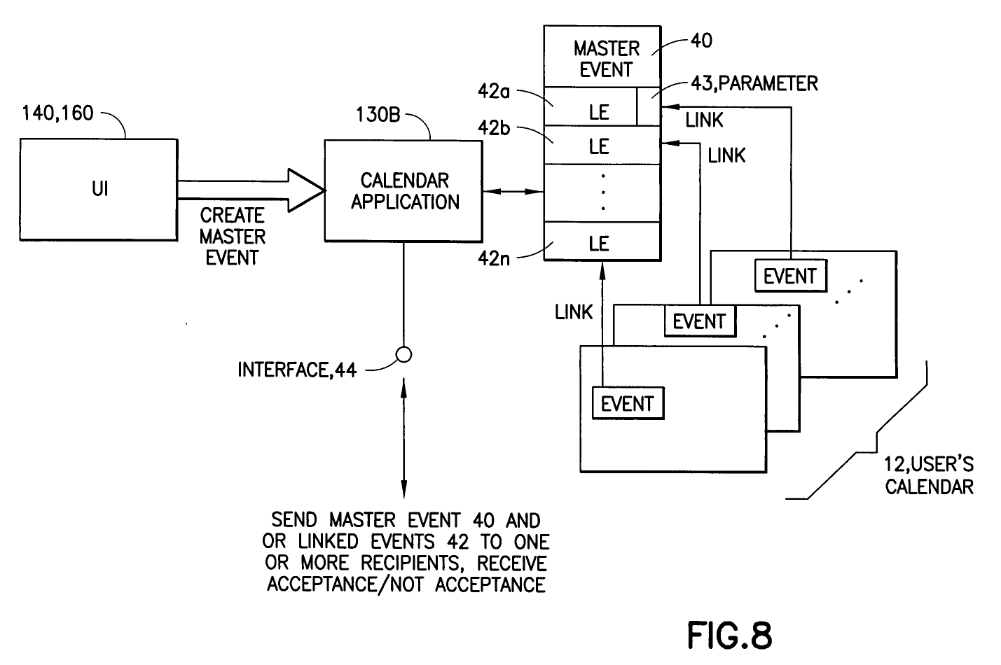

Further in accordance with the exemplary embodiments of this invention, and referring to FIG. 8, there is provided a composite calendar event type, also referred to herein as a master calendar event or simply as a master event 40, that links a plurality of calendar entries 42a, 42b, . . . , 42n, collectively referred to as linked events or linked entries (LEs) 42. Entries 42 linked to the master event 40 may be sent to different recipients as invitations via some interface 44 such as through one of the long range transceiver 210, 220 or the short range (local area) transceiver 170 shown in FIG. 1. Entries 42 linked to the master event 40 may be sent separately. However, sending the master event 40 results in all of the linked events 42 being sent, and one acceptance is interpreted by the calendar application 130B as being an acceptance of all of the linked events 42. A parameter 43 may be selectively set for indicating that a particular linked event 42 is not mandatory for the master entry 40, and canceling a non-mandatory linked event 42 does not result in cancellation of the master entry 40.

As one non-limiting example of the use of this exemplary embodiment, assume a training organization that tracks approvals for disconnected training courses for applicants, and may send and track complex courses with a single invitation. For example, a university may send a complete course catalog with one invitation, and track the acceptance and attendance of individual courses. In this case the individual courses offered may each be associated with the parameter 43 so that acceptance of only one or a few courses would not result in the entire course offering (master event 40) being canceled.

As can be appreciated, this embodiment of the invention provides a special composite type of calendar entry (the master event 40), where other entries (the linked entries 42) can be linked to the master event 40. A plurality of calendar events can be created to be a part of or associated with (linked to) the master event 40, and these calendar entries linked to the master entry 40 can be sent separately, and can be sent to different recipients. Further, the master calendar entry 40 linking all of the other entries 42 can be sent as an invitation, and accepting the master entry 40 is automatically interpreted as an acceptance of all of the linked entries 42. Deleting the master event 40 automatically deletes all of the linked calendar entries 42 at the user's calendar application. When sending the master event 40 the receiving user can be notified with a message that the cancellation of a particular linked event will result in the cancellation of the master event 40.

The user can simply track complex calendar events by the use of this embodiment of the invention, as invitations to complex entries may be sent, and accepted, with a single click. Canceling a single calendar event 42 which is part of the master-event 40 automatically removes all the linked calendar entries 42 from the calendar.

The master event 40 may be considered as a data structure stored in a tangible memory medium (e.g., the memory 130 of FIG. 1) that includes an identification (e.g., “course catalog”) and links to a plurality of individual calendar entries 42. When the master event 40 is sent, the links are followed to retrieve the associated individual calendar entries 42, which are then sent to the recipient for review and possible storage in the recipient's calendar. The master event 40 may be created by the user by designating a command to create a master event, and then clicking on or otherwise designating individual entries in the user's calendar to be linked to and associated with the master event 40. During this creation process the user may designate individual calendar entries 42 as being mandatory or not mandatory, resulting in the parameter 43 being set or not.

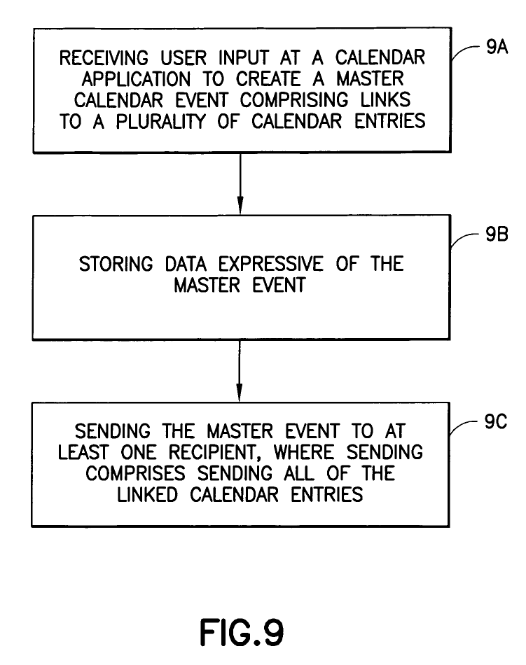

Referring to FIG. 9, a method includes (Block 9A) receiving user input at a calendar application to create a master calendar event comprising links to a plurality of calendar entries; (Block 9B) storing data expressive of the master event; and (Block 9C) sending the master event to at least one recipient, where sending comprises sending all of the linked calendar entries.

The various methods disclosed above may each be executed in a mobile communication device, such as the MS 100 of FIG. 1, and in general the calendar application 130B can be executed by a data processor of a device, such as the MCU 120 of FIG. 1 in a mobile communication device or a PDA, as two non-limiting examples. The performance of the method may thus be a result of the execution of a computer program product embodied in a tangible computer readable medium, such as the memory 130 of FIG. 1.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate. Programs automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

That is, the calendar application unit 130B may be implemented in whole or in part in one or more integrated circuits.

The foregoing description has provided, by way of exemplary and non-limiting embodiments a full and informative description of the invention. However, various modifications and adaptations may become apparent to those skilled in the relevant arts in view of the foregoing description, when read in conjunction with the accompanying drawings and the appended claims.

For example, while described above in at least one non-limiting example as the Calendar Application 130B displaying calendar-related information on the display 140, in other embodiments a remote display could be used, i.e., the calendar application and display need not be co-located in the same device or unit. Also, it should be realized that the exemplary embodiments of this invention can be used with any type of scheduled event, including meetings, concerts, dinner engagements and the like.

As another example, the address book 30 shown in FIG. 3 may comprise a contacts database that is resident in or coupled to the device, such as in the memory 130 of the MS 100 of FIG. 1, or it may be one that is external to the device and reachable through one of the long range transceiver 210, 220 or the short range (local area) transceiver 170.

In addition, it is pointed out that while the exemplary embodiments of this invention have been primarily disclosed in the context of a mobile device (e.g., the MS 100), such as a mobile communication device, the exemplary embodiments may be employed as well in, as non-limiting examples, PC-based and web-based calendar applications. For example, a PC may initiate (or terminate) a mobile phone call (or an IP call, such as a VoIP call) on behalf of a user. That is, all of the exemplary embodiments described above may be embodied in any of a number of device types and systems, and are not intended to be limited in any way to any specific type of device or system.

Thus, all such and similar modifications to the exemplary embodiments of this invention will still fall within the scope of the invention.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
receiving a scheduling event at a calendar application from a user, the scheduling event comprising at least an identification of a task and an amount of time needed to complete the task;
monitoring a calendar of the user with the calendar application to identify an unscheduled period of time having a duration at least equal to the time needed to complete the task; and
notifying the user of an identified unscheduled period of time having the duration at least equal to the time allocated to complete the task.

2. The method of claim 1, where the scheduling event further comprises an identification of a period of time in which to complete the task, and where monitoring comprises monitoring the calendar within the period of time.

3. The method of claim 1, executed in a mobile communication device.

4. The method of claim 1, where the calendar application is executed by a data processor of a device.

5. The method of claim 1, where performance of the method is a result of execution of a computer program product embodied in a tangible computer readable medium.

6. A method, comprising:
receiving from a user a scheduling request at a calendar application, the scheduling request comprising at least a time and a list of proposed participants for a proposed event;
sending invitations to the proposed event from the calendar application, via at least one interface, to the proposed participants; and
the calendar application monitoring received invitation responses for fulfillment of at least one criterion for determining if the proposed event is to be a scheduled event.

7. The method of claim 6, where if the at least one criterion is not fulfilled, further comprising the calendar application re-sending the invitation to those proposed participants who rejected the invitation.

8. The method of claim 6, further comprising sending an event status to the user and at least to those proposed participants who accepted the invitation.

9. The method of claim 6, where the at least one criterion comprises a minimum number of participants that must accept the invitation before the event is to be scheduled.

10. The method of claim 6, where the at least one criterion comprises an identification of certain participants that must accept the invitation before the event is to be scheduled.

11. The method of claim 6, where sending the invitation includes a preliminary operation of retrieving a contact address of at least one proposed participant from a contacts database.

12. The method of claim 6, executed in a mobile communication device.

13. The method of claim 6, where the calendar application is executed by a data processor of a device.

14. The method of claim 6, where performance of the method is a result of execution of a computer program product embodied in a tangible computer readable medium.

15. A method, comprising:
receiving from a user a scheduling request at a calendar application, the scheduling request comprising at least a list of proposed participants for a proposed event and a duration of the event expressed in a man-[time unit] format;
converting the man-[time unit] to calendar time based on the list of proposed participants;
sending invitations to the proposed event from the calendar application, via at least one interface, to the proposed participants, the invitations including the calendar time; and
the calendar application monitoring received invitation responses and modifying the calendar time as needed.

16. The method of claim 15, where for a case where not all proposed participants accept the invitation, further comprising re-sending the invitation, with the modified calendar time, to those proposed participants who previously accepted the invitation.

17. The method of claim 15, executed in a mobile communication device.

18. The method of claim 15 where the calendar application is executed by a data processor of a device.

19. The method of claim 15, where performance of the method is a result of execution of a computer program product embodied in a tangible computer readable medium.

20. A method, comprising:
receiving from a user a scheduling request at a calendar application, the scheduling request comprising a set of modular units;
sending an invitation to at least one invitee; and
receiving a response to the invitation, the response comprising an approval or a rejection of the set of modular units.

21. The method of claim 20, executed in a mobile communication device.

22. The method of claim 20, where the calendar application is executed by a data processor of a device.

23. The method of claim 20, where performance of the method is a result of execution of a computer program product embodied in a tangible computer readable medium.

24. A device, comprising:
a calendar application unit; and
a user interface adapted to receive a scheduling event from a user and having an output coupled to said calendar application unit, the scheduling event comprising at least an identification of a task and an amount of time needed to complete the task;
said calendar application unit configured to monitor a calendar of the user to identify an unscheduled period of time having a duration at least equal to the time needed to complete the task and to notify the user via said user interface of an identified unscheduled period of time having the duration at least equal to the time allocated to complete the task.

25. The device of claim 24, where the scheduling event further comprises an identification of a period of time in which to complete the task, and where said calendar application unit is adapted to monitor the calendar within the period of time.

26. The device of claim 24, comprising a mobile communication device.

27. The device of claim 24, where said calendar application unit is embodied at least in part in a computer program product embodied in a tangible computer readable medium that is executable by a data processor of the device.

28. The device of claim 24, where said calendar application unit is embodied at least in part in an integrated circuit.

29. A device, comprising:
a calendar application unit; and
a user interface adapted to receive a scheduling request from a user and having an output coupled to said calendar application unit, the scheduling request comprising at least a time and a list of proposed participants for a proposed event;
said calendar application unit being adapted to send invitations to the proposed event, via at least one interface, to the proposed participants and further configured to monitor received invitation responses for fulfillment of at least one criterion for determining if the proposed event is to be a scheduled event.

30. The device of claim 29, where if the at least one criterion is not fulfilled, said calendar application unit is further adapted to re-send the invitation to those proposed participants who rejected the invitation.

31. The device of claim 29, said calendar application being further adapted to send an event status to the user, via said user interface, and at least to those proposed participants who accepted the invitation, via said at least one interface.

32. The device of claim 29, where the at least one criterion comprises a minimum number of participants that must accept the invitation before the event is to be scheduled.

33. The device of claim 29, where the at least one criterion comprises an identification of certain participants that must accept the invitation before the event is to be scheduled.

34. The device of claim 29, said calendar application unit being further adapted, prior to sending the invitation, to retrieve a contact address of at least one proposed participant from a contacts database.

35. The device of claim 29, comprising a mobile communication device.

36. The device of claim 29, where said calendar application unit is embodied at least in part in a computer program product embodied in a tangible computer readable medium that is executable by a data processor of the device.

37. The device of claim 29, where said calendar application unit is embodied at least in part in an integrated circuit.

38. A device, comprising:
a calendar application unit; and
a user interface adapted to receive a scheduling request from a user and having an output coupled to said calendar application unit, the scheduling request comprising at least a list of proposed participants for a proposed event and a duration of the event expressed in a man-[time unit] format;
said calendar application unit being configured to convert the man- [time unit] to calendar time based on the list of proposed participants and to send invitations to the proposed event, via at least one interface, to the proposed participants, the invitations including the calendar time, said calendar application unit being further configured to monitor received invitation responses and to modify the calendar time in accordance with received invitation response, as needed.

39. The device of claim 38, where for a case where not all proposed participants accept the invitation, said calendar application unit being further configured to re-send the invitation, with the modified calendar time, at least to those proposed participants who previously accepted the invitation.

40. The device of claim 38, comprising a mobile communication device.

41. The device of claim 38, where said calendar application unit is embodied at least in part in a computer program product embodied in a tangible computer readable medium that is executable by a data processor of the device.

42. The device of claim 38, where said calendar application unit is embodied at least in part in an integrated circuit.

43. A device, comprising:
a calendar application unit; and
a user interface adapted to receive a scheduling request from a user and having an output coupled to said calendar application unit, the scheduling request comprising a set of modular units;
said calendar application unit being configured to send an invitation to at least one invitee, via an interface, and to receive a response to the invitation via the interface, the response comprising an approval or a rejection of the set of modular units.

44. The device of claim 43, comprising a mobile communication device.

45. The device of claim 43, where said calendar application unit is embodied at least in part in a computer program product embodied in a tangible computer readable medium that is executable by a data processor of the device.

46. The device of claim 43, where said calendar application unit is embodied at least in part in an integrated circuit.

47. A method, comprising:
receiving user input at a calendar application to create a master calendar event comprising links to a plurality of calendar entries;
storing data expressive of the master event; and
sending the master event to at least one recipient, where sending comprises sending all of the linked calendar entries.

48. The method of claim 47, where rejection of a single calendar event by the recipient is interpreted as a rejection of all of the linked calendar entries, unless the rejected calendar event is designated as not being a mandatory calendar event.

49. The method of claim 47, where acceptance of master calendar event by the recipient is interpreted as an acceptance of all of the linked calendar entries.

50. The method of claim 47, executed in a mobile communication device.

51. The method of claim 47, where the calendar application is executed by a data processor of a device.

52. The method of claim 47, where performance of the method is a result-of execution of a computer program product embodied in a tangible computer readable medium.

53. A device, comprising:
a calendar application unit; and
a user interface to apply user input to said calendar application unit, said calendar application unit configured to create a master calendar event comprising links to a plurality of calendar entries, to store data expressive of the master event, and is further configured to send the master event to at least one recipient, where sending the master event comprises sending all of the linked calendar entries.

54. The device of claim 53, where a rejection of a single calendar event by the recipient is interpreted as a rejection of all of the linked calendar entries, unless the rejected calendar event is designated as not being a mandatory calendar event.

55. The device of claim 53, where acceptance of master calendar event by the recipient is interpreted as an acceptance of all of the linked calendar entries.

56. The device of claim 53, comprising a mobile communication device.

57. The device of claim 53, where said calendar application unit is embodied at least in part in a computer program product embodied in a tangible computer readable medium that is executable by a data processor of the device.

58. The device of claim 53, where said calendar application unit is embodied at least in part in an integrated circuit.
